(19) United States
(12) Patent Application Publication
(10) Pub. No.: US 2010/0278236 A1
(43) Pub. Date: Nov. 4, 2010

(54) REDUCED VIDEO FLICKER

(76) Inventors: Hua Yang, Plainsboro, NJ (US); Jill MacDonald Boyce, Manalapan, NJ (US); Gad Moshe Berger, Dayton, NJ (US)

Correspondence Address: Robert D. Shedd, Patent Operations;THOMSON Licensing LLC, P.O. Box 5312, Princeton, NJ, 08543-5312, US

(21) Appl. No.: 12/735,342

(22) PCT Filed: Dec. 22, 2008
(86) PCT No.: PCT/US2008/013962

§ 371 Date: Jul. 7, 2010

Related U.S. Application Data
(60) Provisional application No. 61/011,485, filed on Jan. 17, 2008.

(51) Int. Cl. H04N 7/32

(52) U.S. Cl. 375/240.13; 375/E07.243

(57) ABSTRACT

Various implementations for reducing artifacts such as, for example, I-frame flicker are proposed. Particular implementations produce a no-flicker reference in which a picture intended to be coded as an I-frame is, first, coded as a P-frame using a reference picture from the previous GOP. Thus, continuity with the previous GOP is provided. According to a general aspect, a source image is inter-coded to produce coded source data. The coded source data is decoded to produce a modified source. The modified source is intra-coded to produce coded modified-source data. The coded modified-source data is decoded to produce a reference image.

### CROSS-REFERENCE

This patent application claims the benefit of and priority to U.S. Provisional Patent Application No. 61/011,485, filed Jan. 17, 2008, and titled “De-Flickering Video Sequences”. The provisional application is expressly incorporated herein by reference in its entirety for all purposes.

### BACKGROUND

1. Technological Field

At least one disclosed implementation generally relates to video processing and, more particularly, to compressed video.

2. Background

In some digital video processing approaches, video is coded into groups of pictures (GOPs). Certain approaches have the following characteristics. The first frame of each GOP is coded as an I-frame. The last frame of each GOP is coded as a P-frame. The remaining frames of the GOP are coded as either P-frames or B-frames. P- or B-frames involve inter-frame prediction, also called inter-prediction. In contrast, I-frames involve either intra-frame prediction, also called intra-prediction, or no prediction at all. P-frames involve inter-prediction from prior frames only. However, B-frames involve inter-prediction from both prior and subsequent frames. When playing out a GOP coded video, a pulsing, or the so called flickering artifact, will usually be seen at the periodic I-frames for the GOPs in the same scene. Especially for low or medium bit rate video coding, this I-frame flickering is easily seen, and may greatly compromise the overall perceptual quality of the coded video.

Original video signals have naturally smooth optical flows. However, after lossy video encoding, the natural optical flow will be distorted in the coded video signals. The resultant temporal inconsistency across coded frames will then be perceived as the flickering artifact. In practice, flickering is more often perceived in static or low motion areas of a coded video. For example, several consecutive frames may share the same static background. Hence, all the collocated pixels in the static background across these frames bear the same or similar pixel values in the original input video. However, in video encoding, the collocated pixels of these frames may be predicted from different reference pixels in different frames, and hence after quantizing the residue, may yield different reconstruction values. Visually, the increased inter-frame differences across these frames will be perceived as flickering when the coded video is playing out.

As such, a flickering artifact is typically more intensive for low or medium bit rate coding due to coarse quantization. Also, it is typically more obviously observed on I-frames than on P- or B-frames. This may be because for the same static areas, the prediction residue resultant from inter-frame prediction in P- or B-frames is usually much smaller than the resultant from intra-frame prediction or no-prediction in I-frames. Thus, with coarse quantization, the reconstructed static areas in an I-frame may demonstrate more noticeable difference from the collocated areas in previous P- or B-frames, and hence, a more noticeable flickering artifact.

### SUMMARY

According to a general aspect, a source image is inter-coded to produce coded source data. The coded source data is decoded to produce a modified source. The modified source is intra-coded to produce coded modified-source data. The coded modified-source data is decoded to produce a reference image.

The details of one or more implementations are set forth in the accompanying drawings and the description below. Even if described in one particular manner, it should be clear that implementations may be configured or embodied in various manners. For example, an implementation may be performed as a method, or embodied as an apparatus configured to perform a set of operations, or embodied as an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 is a schematic diagram of a relationship among frames at the end of one group of pictures and the beginning of a next group of pictures.

FIG. 2 is a block diagram of an implementation of an apparatus for encoding and transmitting or storing picture data.

FIG. 3 is a block diagram of an implementation of an apparatus for processing and transmitting or storing picture data.

FIG. 4 is a schematic diagram of another relationship among frames at the end of one group of pictures and the beginning of a next group of pictures in an implementation.

FIG. 5 is a process flow diagram of an implementation of a method for reducing an artifact in a portion of a reference frame.

FIG. 6 is a process flow diagram of another implementation of a method for reducing an artifact in a portion of a reference frame.

FIG. 7 is a block diagram of an implementation of an encoder adapted to reduce an artifact in a portion of a reference frame.

FIG. 8 is a process flow diagram of another implementation of a method for reducing an artifact in a portion of a reference frame.

FIG. 9 is a block diagram of an implementation of a video transmission system.

FIG. 10 is a block diagram of an implementation of a video receiving system.

The implementations (also referred to as embodiments) set out herein are intended as examples of particles features and aspects. Such implementations are not to be construed as limiting the scope of this disclosure or the scope of contemplated implementations in any manner.

### DETAILED DESCRIPTION

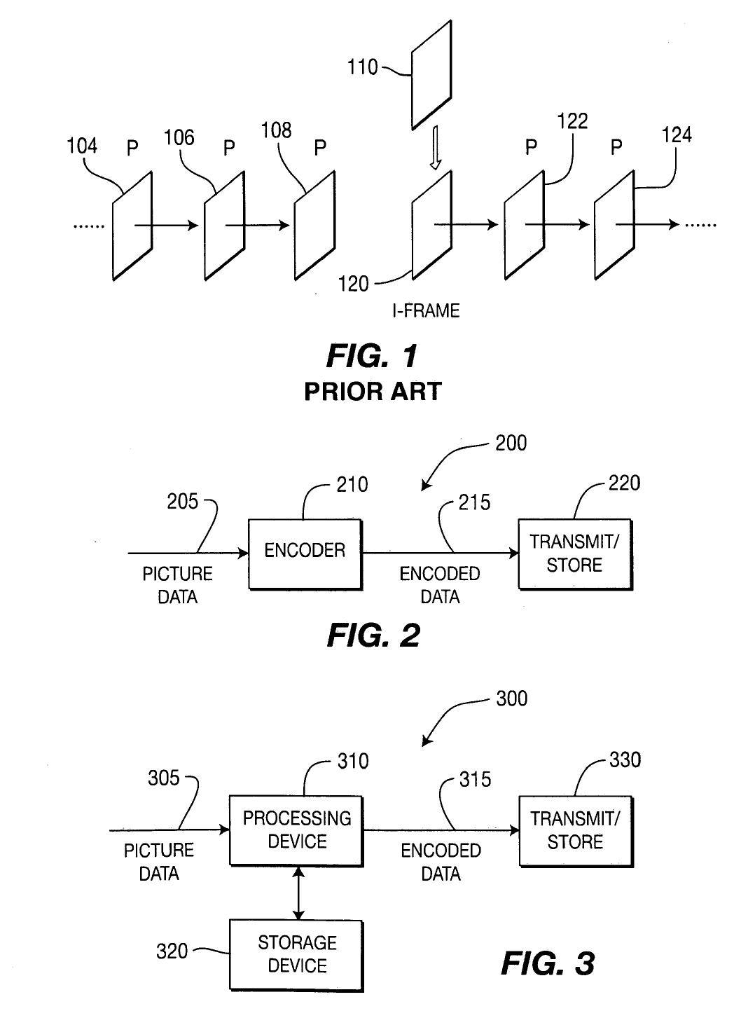

As mentioned above, the artifact called flicker may result from changing from one group of pictures to a next group of pictures in a single scene. Referring to FIG. 1, a digital video sequence is shown schematically. The final three P-frames 104, 106, 108 of a group of pictures are shown. Note that the term “frames” is used in referring to I-frames, P-frames, and B-frames for convenience and due to the familiarity of the terms. However, the more general term “pictures” is understood to be applicable and implementations may use I-pictures, P-pictures, and/or B-pictures. The P-frames 104, 106, 108, 122, 124, and the I-frame 120 all represent actual frames having pixel data. Each of these frames is a reconstruction (that is, decoded version of) a source frame. For example, source frame 110 is coded to produce coded data (for example, a coded bitstream) that represents the encoding. The coded data is then decoded to produce a reconstructed frame which is I-frame 120.

P-frames 104, 106, 108 use an I-frame of the first group of pictures as a reference. That I-frame was in turn encoded from a source frame. A source frame 110 is encoded as the I-frame 120 of a next group of pictures. P-frames 122, 124 use I-frame 120 as a prediction reference frame. Flicker results from a discontinuity between P-frame 108 and I-frame 120.

One challenge is to reduce flicker in a manner that is transparent to the decoder. We note that a variety of different decoders may be used for any video. Accordingly, it is advantageous for any method and system of de-flickering to be implemented at an encoder and prior to transmission.

Referring to FIG. 2, in one implementation a system 200 includes an encoder 210 coupled to a transmit/store device 220. The encoder 210 and the transmit/store device 220 may be implemented, for example, on a computer or a communications encoder. The encoder 210 accesses unencoded picture data 205, and encodes the picture data according to one or more of a variety of coding algorithms, and provides an encoded data output 215 to the transmit/store device 220. The transmit/store device 220 may include one or more of a storage device or a transmission device. Accordingly, the transmit/store device 220 accesses the encoded data 215 and either transmits the data 215 or stores the data 215.

Referring to FIG. 3, in one implementation a system 300 includes a processing device 310 coupled to a local storage device 320 and coupled to a transmit/store device 330. The processing device 310 accesses unencoded picture data 305. The processing device 310 encodes the picture data according to one or more of a variety of coding algorithms, and provides an encoded data output 315 to the transmit/store device 330. The processing device 310 may include, for example, the encoder 210. The processing device 310 may cause data, including unencoded picture data, encoded picture data, and elements thereof to be stored in the local storage device 320, and may retrieve such data from the local storage device 320. The transmit/store device 330 may include one or more of a storage device or a transmission device. Transmit/store device 330 may transmit the encoded picture data, including intra-coded reconstructed portions and inter-coded subsequent portions, as discussed below, to one or more decoders for decoding.

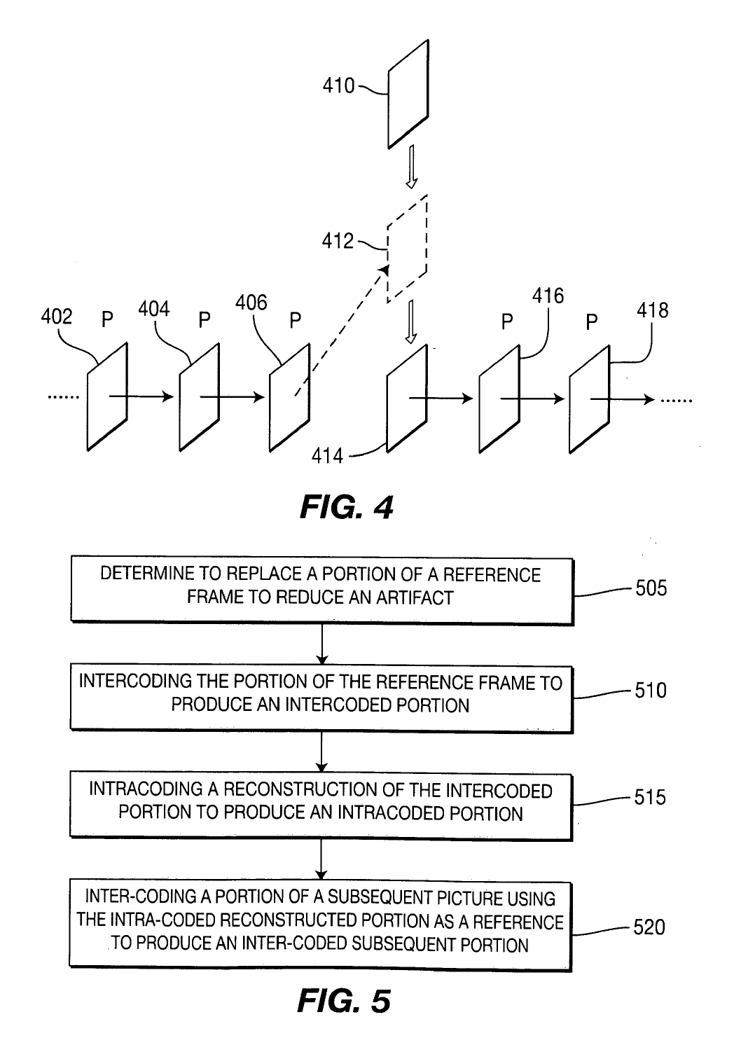

Referring to FIG. 4, in an implementation, a two-pass method for I-frame coding with reduced flickering is illustrated. An I-frame in a video is an example of an I-picture, and a P-frame in a video is an example of a P-picture. In a group of pictures of the illustrated implementation, P-frames 402, 404, 406 are the final frames of a group of pictures. A no-flicker reference frame 412 is formed by encoding the unencoded current frame 410 to form a P-frame 412, predicted from previously coded P-frame 406. That is, the source frame 410 is inter-coded, using P-frame 406 as a prediction reference. The inter-coding, in a typical implementation, produces coded data that is decoded to produce the P-frame 412. The P-frame 412 is then intra-coded (I-frame encoded) to produce coded data. The coded data is then decoded to produce I-frame 414. Thus, I-frame 414 is based on a “source” of P-frame 412. So the original source frame 410 has effectively been coded twice. The first coding produces the no-flicker reference 412, and the second coding provides an intra-coded frame 414 to being a new GOP.

In one implementation, the current frame 410 is coded on a macroblock by macroblock basis in two passes. In a first pass, a macroblock of frame 410 is coded as a P-frame macroblock, and the resultant reconstruction is taken as a macroblock of the no-flicker reference 412. This is done for each macroblock of frame 410 separately.

Although the frame 410 may be coded using a standard P-frame coding procedure, the process of P-frame coding is resource-intensive. Accordingly, a less resource-intensive process, referred to as pseudo-P-frame-coding, is used in one implementation. A pseudo-P-frame coding may be referred to as, for example, a partial inter-frame coding according to the ITU-T H.264 standard, which means that the normal inter-frame coding process of the standard is only partially performed. Thus, a macroblock from frame 410 is pseudo-P-frame coded, and then reconstructed, to produce a macroblock of frame 412. The pseudo-P-frame coding process may include, for example, not performing an entropy coding step. Thus, the P-frame 412 macroblock is reconstructed from quantized data without performing an entropy decoding step. The pseudo-P-frame coding process may also, or alternatively, include, for example, not checking all available coding modes, as explained further below.

In one implementation, the macroblock of P-frame 412 is generated so that the distortion of this macroblock is close to the distortion of the corresponding macroblock in the prediction reference P-frame 406. Recall that the distortion of the macroblock of P-frame 412 is with respect to the corresponding macroblock in source frame 410. Recall also that the corresponding macroblock of P-frame 406 is determined when the macroblock of source frame 410 is P-frame coded (or pseudo-P-frame-coded). Recall that the distortion of the corresponding macroblock of P-frame 406 is with respect to the corresponding macroblock in its source frame (not shown).

In a second pass, the macroblock of the no-flicker reference 412 is intra-coded to produce a macroblock of I-frame 414 of the next group of pictures. This second pass uses the no-flicker reference 412 macroblock, instead of the original 410 macroblock, as the target macroblock. A small quantization parameter (“QP”) is applied in quantization to ensure that the reconstructed macroblock of I-frame 414 closely approaches the target macroblock of P-frame (no-flicker reference frame) 412.

In this implementation, the two passes in the method are: (i) deriving a no-flicker reference as the target frame; and (ii) conducting actual I-frame coding with a small enough QP (or with enough coding bits) to closely approach the target frame. In this way, the annoying I-frame flickering artifact can be effectively removed, or at least reduced, from the coded video, as observed in extensive experiments.

In FIG. 4, the next group of pictures continues with P-frames 416, 418. In an implementation, frames 416, 418, and/or succeeding frames in the GOP, may be B-frames. Portions (such as macroblocks) of frames 416, 418 may be inter-coded using the corresponding portions of I-frame 414 as a reference. Such inter-coding will produce an inter-coded portion, such as an inter-coded macroblock. In an implementation, there are two reconstructions. The first reconstruction is no-flicker reference frame 412, which is a P-frame coding of frame 410. The second reconstruction is I-frame 414, which is used as the reference for encoding frames 416, 418.

Note that the above 2-pass implementation is performed on a macroblock-by-macroblock basis. In this way, the entire frame 412 does not need to be stored or generated at one time. After a macroblock of frame 412 is generated and I-frame coded, and after the macroblock is no longer needed, then the macroblock may be discarded (that is, removed from memory and no longer stored or saved). As a result, this implementation requires less memory than an implementation that generates and stores the entire frame 412. Further, the use of a pseudo-P-frame coding process allows savings, for example, in terms of processing requirements.

Referring now to FIG. 5, a process flow of a method according to an implementation will be explained. The method may be implemented by encoder 210 of FIG. 2, for example, and may be implemented by processing device 310 of FIG. 3. Referring again to FIG. 5, the process flow may commence with determining 505, for a portion of a reference picture, to replace the portion. Note that the term “reference image” refers to all or part of a reference picture, such as, for example, a macroblock. The determination may be made, for example, in order to reduce an artifact when an encoding of the reference picture is decoded and displayed. If it is determined to replace the portion, the process flow may continue with replacing the portion. Replacing the portion includes (1) inter-coding 510 the portion of the reference picture to produce an inter-coded portion, and (2) intra-coding 515 a reconstruction of the inter-coded portion to produce an intra-coded reconstructed portion. The process flow continues with inter-coding 520 a portion of a subsequent picture using the intra-coded reconstructed portion as a reference to produce an inter-coded subsequent portion.

In an implementation, the determining 505 may include performing an optimal rate-distortion evaluation of multiple options for replacing the portion. Based on the evaluation, an optimal option may be selected. The multiple options may include at least one inter-coding mode from an applicable video compression standard, and one intra-coding mode from the applicable standard. The standard may be, for example, the ITU-T H.264 standard, which is equivalent to the ISO/IEC MPEG-4 Part 10 standard (also called MPEG-4 AVC and ISO/IEC 14496-10), MPEG-2, 1-1.263, or MPEG-4 Part 2, by way of example. The multiple options may include inter-coding with a 16×16 block size, intra-coding with a 16×16 block size, and intra-coding with a 4×4 block size.

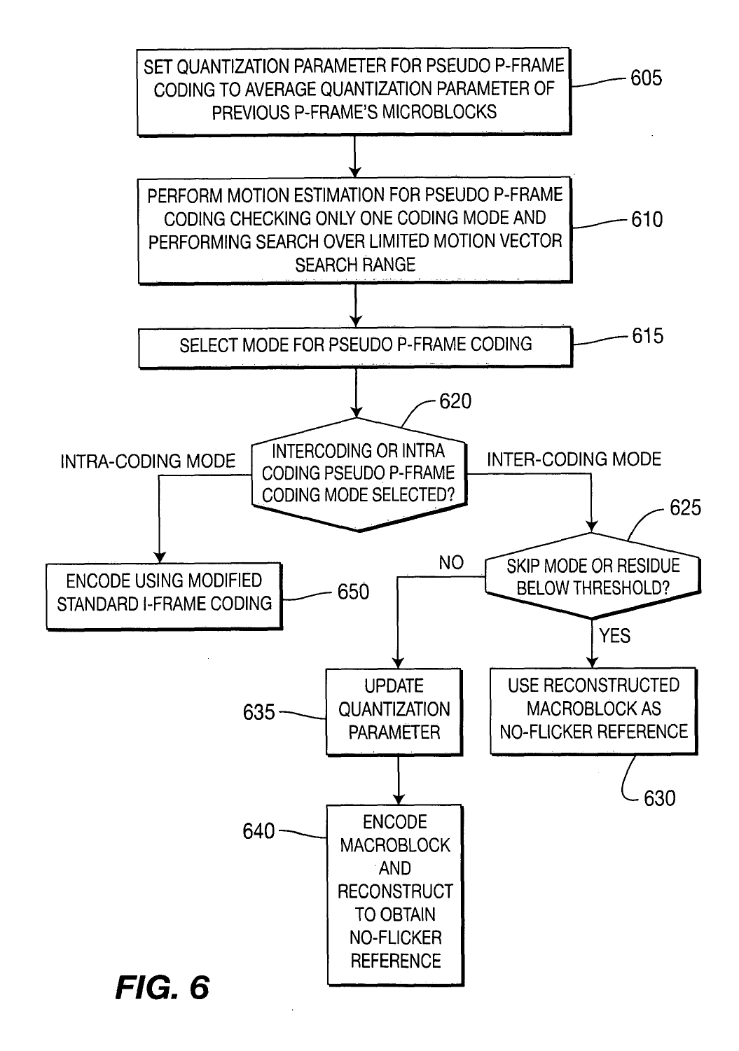

Referring now to FIG. 6, a process flow of an implementation will be discussed. In an implementation, the process flow may be carried out for multiple portions of a picture, or each portion of a picture. The portions may be macroblocks, by way of example. The picture may be an I-picture, and may be the first picture in a group of pictures. The I-picture may be a reference frame. The process flow commences with determining whether to pseudo-P-code a portion of the reference frame. In determining whether to pseudo-P-code a portion of a reference frame, a quantization parameter is selected 605 for a pseudo P-frame coding equal to the average quantization parameter of all of the macroblocks of the previously coded P-frame, i.e., the last P-frame of the prior group of pictures. The quantization parameter may be selected for the entire picture.

The process flow proceeds to performing 610 motion estimation for pseudo P-frame coding. In performing motion estimation, checking only one coding mode may be employed. In an implementation, only the Inter16×16 mode may be checked, although a different mode may be the only mode checked. More than one coding mode may also be checked. Other modes include, for example, Inter16×8 and Inter8×16. The motion vector is estimated, for example, using the motion vectors of one or more neighboring macroblocks. The search may be performed over a limited motion vector search range. The search attempts, for example, to minimize a measure of the residue resulting from various motion vectors. A measure may be, for example, the sum of absolute differences (“SAD”) or the sum of square differences (“SSD”). In an implementation, the motion vector search range may be [−5, +5]. However, other limited search ranges, e.g., 3, 6, or 10 pixels, may be employed. As the goal of identifying macroblocks with a high probability of flicker is identifying macroblocks that change not at all or very little, checking only the Inter 16×16 mode and searching over a limited motion vector search range is sufficient to find the accurate motion for low or medium motion macroblocks. In an implementation, either integer pixel level or subpixel, e.g., at the ½ pixel or Vs pixel levels, level motion vector search may be performed. In experiments, superior deflickering has been obtained through subpixel level motion vector search.

After motion estimation, a mode is selected 615 for pseudo P-frame coding. The process of mode selection is also the final step in determining whether to perform pseudo P-frame coding. If the mode selection process returns a result of intracoding, then pseudo P-frame coding is not performed. The mode selection process may be performed by using an optimal rate-distortion evaluation, such as a rate-distortion optimized encoding strategy, using the mode that results in a minimum of a Lagrangian rate-distortion cost analysis. In an implementation, four coding modes may be checked, which may be: Skip (in which a motion vector based on a previous macroblock is used), Inter16×16, Intra16×16, and Intra4×4. The Lagrangian rate-distortion costs of at least one mode may be multiplied by a factor in order to to compensate for the absence of other modes. For example, the Lagrangian rate-distortion costs of the Skip and Inter16×16 modes are multiplied by a factor, which may be 0.7. This attempts to compensate for the absence of the other Inter-prediction modes that may have produced better results. If additional coding modes are checked in an implementation, then the Lagrangian rate-distortion costs of certain modes may need to be multiplied by a different factor.

If the selected mode is an inter-coding mode 620, then a relatively low motion macroblock is indicated. The process flow then proceeds to indicate whether the macroblock is characterized by very low motion or moderately low motion. If the selected mode is Skip mode, or the prediction residue is below a threshold, then a very low motion macroblock is indicated. The implementation is therefore satisfied with the QP value. If either of those is true 625, then the macroblock is reconstructed 630 with the selected mode (that is, the selected mode is used to code the macroblock, and then the coded data is decoded) and the reconstructed macroblock is used as the no-flicker reference. In an implementation, the prediction residue threshold may be represented as the mean-absolute-difference being less than 10.

If neither of those is true (so, skip mode not selected, and residue is not below a threshold), then an updated quantization parameter for the no-flicker reference is determined 635. The QP is implicitly assumed to be too high, as evidenced by the residue being above a threshold. An updated quantization parameter may be selected which minimizes, or at least reduces, the mean-square-error (MSE) distortion difference between the current macroblock coded using Inter16×16 mode and the prediction macroblock from the previous P-frame. That is, we attempt to make the distortion of the current macroblock (measured with respect to the original source) the same as the distortion of the prediction macroblock (measured with respect to its source). The macroblock may be encoded 640 using Inter 16×16 mode and using the updated quantization parameter to obtain, after reconstruction, the no-flicker reference for the current macroblock.

A second pass may include applying de-flickering I-frame coding to the no-flicker macroblock produced in either of operations 630 or 640. The applying of de-flickering I-frame coding may include checking all the Intra-prediction modes; using the no-flicker reference derived from the first pass pseudo P-frame coding as the target macroblock; and using a small quantization parameter, such that the reconstruction closely approaches the no-flicker reference.

If the selected mode is an intra-coding mode, this indicates that the macroblock has relatively high motion. Relatively high motion is associated with a low risk of flicker. Based on an indication of relatively high motion, the process flow proceeds to encode 650 the macroblock of the original source employing standard I-frame coding. In one implementation, at least one modification is used to try and provide consistent picture quality within the resulting I frame. The modification may be, for example, to use the macroblock average quantization parameter of the last frame of the prior group of pictures, as determined in operation 605. The consistency arises at least in part because the no-flicker macroblocks of operation 630 are also generated using the QP from operation 605, and then these no-flicker macroblocks may be I-frame encoded using a small QP (which tends to provide a similar level of quality as the no-flicker macroblock itself).

In an implementation, the quantization parameter may be a fixed value for all the macroblocks in the frame. The fixed value is determined in the earlier frame-level bit allocation for the current I-frame. In frame-level rate control, the total bit budget is allocated to each frame such that every frame achieves the same coding quality or similar coding quality. For example, in an implementation, the allocated bits of each frame may be determined by assuming every frame will be coded with the same quantization parameter, QP, resulting in approximately the same quality, while consuming all the available bits.

In an implementation, to ensure good flickering removal performance, many more bits are allocated to the I-frame of a GOP than is conventional. Hence, in an implementation, a negative offset (denoted by −ΔQP₁) is additionally applied to the I-frame quantization parameter, QP₁.

The ratio of Intra-coded macroblocks to total macroblocks in the previous P-frame is denoted as prevFrmIntraRatio. In an implementation, the following values may be employed for the negative offset:

$$- Δ {QP}_{I} = \{ \begin{matrix}- 9 , if prevFrmIntraRatio < 0.1 \\ \begin{matrix}- 6 , if prevFrmIntraRatio ∈ [ 0.1 , 0.2 ] \\ - 3 , if prevFrmIntraRatio > 0.2\end{matrix}\end{matrix} \qquad ( 1 )$$

The lower the value of prevFrmIntraRatio, the lower the motion of the previous frame because intra-coding is typically associated with motion. Additionally, the current frame is assumed to have similar motion levels as the previous frame. Recall that low motion areas are more susceptible frame to flickering. Accordingly, larger values of the negative offset ΔQP₁ are applied for lower motion. As a result, more bits are used to code the I-frame if the motion is lower, thereby improving de-flickering. Hence, in an implementation, the value of the quantization parameter actually employed in coding the I-frame QP_{actual}_{_{—}}_{coding} is calculated using Equations (2) and (3) as follows.

$${QP}^{*} = arg {min}_{QP} \vert {R}_{I} ( QP - Δ {QP}_{I} ) {\sum }_{i = 2}^{N} {R}_{i} ( QP ) - {R}_{GOP} \vert \qquad ( 2 )$$

In Equation (2), it is assumed that for a group of pictures (GOP), only the first frame is an I-frame. N denotes the total number of frames in the GOP, and R_{GOP} denotes the total bit budget of the GOP. R₁ denotes the number bits of the I-frame, and Rᵢ denotes the number of bits of frame i. Equation 2 provides the QP (denoted QP*) that results in the target bit allocation. As can be seen, the same QP is assumed for the initial I-frame and all subsequent frames in the GOP.

The value of the quantization parameter actually employed in coding the I-frame is given in Equation 3:

QP_{actual}_{_{—}}_{coding}=QP*−ΔQP₁. (3)

The use of the negative offset value results in a higher weight being assigned to the I-frame relative to conventional bit allocation strategies. As a result, a larger proportion of the bit budget of the GOP is assigned to the I-frame than in conventional bit allocation strategies. The above process results in a desirable quantization parameter to accommodate allocation of a higher than conventional proportion of bits to the I-frame. In an implementation, a different formula may be employed to determine the number of bits to assign to the I-frame. For example, in an implementation, the number of bits allocated to the I-frame may be increased by a percentage, which may be heuristically determined.

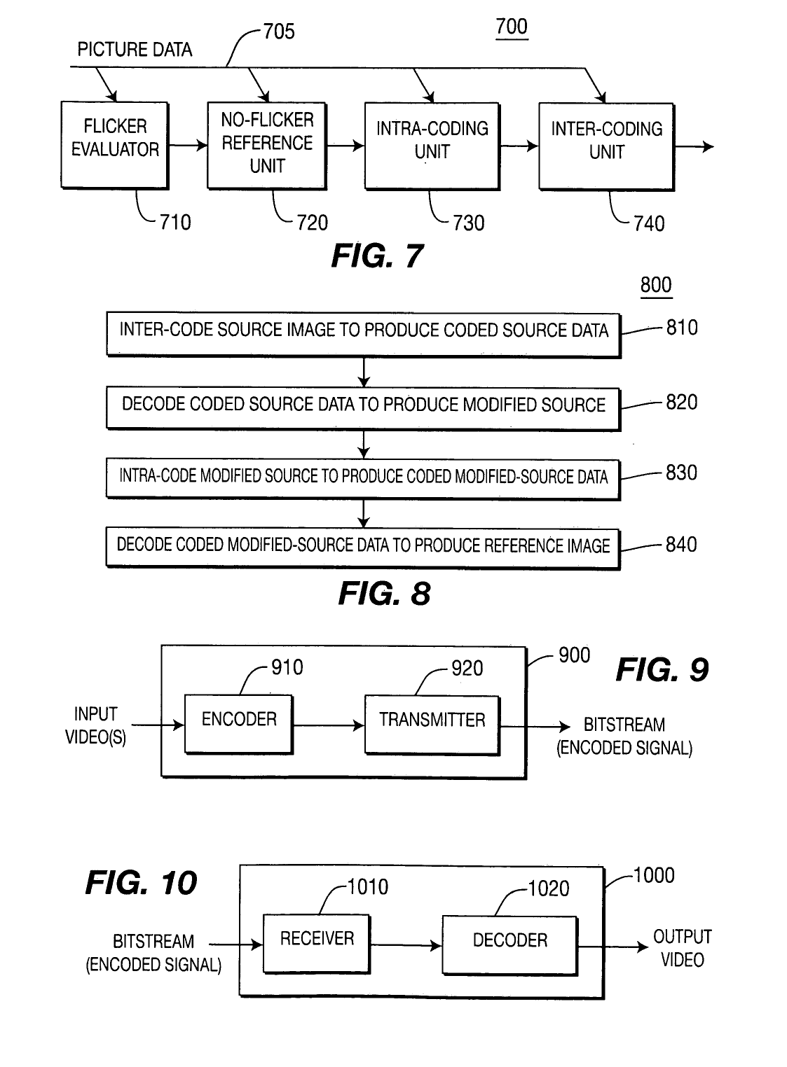

Referring now to FIG. 7, an encoder 700 according to an implementation is shown in a block diagram. Encoder 700 receives picture data 705 and provides the data to flicker evaluator 710 for determining whether or not a no-flicker reference is to be generated for a given portion of picture data. This decision can also be characterized as determining whether or not an inter-coding operation, such as a pseudo-P-frame coding, is to be performed for the given portion of picture data. Flicker evaluator 710 may perform, for example, operations 605-620 of FIG. 6. Flicker evaluator 710 is coupled to a no-flicker reference unit 720.

If a no-flicker reference is to be generated, then flicker evaluator 710 provides an indication of that decision, as well as any other appropriate information, to no-flicker reference unit 720. No-flicker reference unit 720 generates a no-flicker reference for the given portion of picture data by, for example, inter-coding the given portion of picture data to produce coded data, and decoding the coded data to produce a modified portion of picture data. No-flicker reference unit 720 accesses the picture data using input 705. No-flicker reference unit 720 may perform, for example, operations 625-640 of FIG. 6. No-flicker reference unit 720 is coupled to an intra-coding unit 730 and provides the no-flicker reference to intra-coding unit 730.

Intra-coding unit 730 generates a reference image for the no flicker reference by intra-coding the modified portion of picture data to produce coded data, and decoding the coded data to produce the reference image. Intra-coding unit 730 may perform, for example, I-frame coding, or modified I-frame coding, of the no flicker reference produced in operations 630 and 640 of FIG. 6. Intra-coding unit 730 is coupled to an inter-coding unit 740 and provides the reference image to inter-coding unit 740.

Inter-coding unit 740 inter-codes a subsequent image using the reference image as a reference. Inter-coding unit 740 may, for example, use a reference image such as I-frame 414 to code subsequent P-frames 416 and 418, as shown in FIG. 4. Inter-coding unit 740 accesses the subsequent images from the picture data input 705. Inter-coding unit 740 provides the reconstructions of the inter-coded images, for example, P-frames 416 and 418, as output.

FIG. 8 shows a process 800 for producing a reference image. Process 800 includes inter-coding a source image to produce coded source data (810). Process 800 further includes decoding the coded source data to produce a modified source (820). Operations 810 and 820 may be performed, for example, by no-flicker reference unit 720.

Process 800 includes intra-coding the modified source to produce coded modified-source data (830). Process 800 further includes decoding the coded modified-source data to produce a reference image (840). Operations 830 and 840 may be performed, for example, by intra-coding unit 730.

FIG. 9 shows a video transmission system 900, to which the present principles may be applied, in accordance with an implementation of the present principles. The video transmission system 900 may be, for example, a head-end or transmission system for transmitting a signal using any of a variety of media, such as, for example, satellite, cable, telephone-line, or terrestrial broadcast. The transmission may be provided over the Internet or some other network.

The video transmission system 900 is capable of generating and delivering video. content. This is achieved by generating an encoded signal(s) including video information.

The video transmission system 900 includes an encoder 910 and a transmitter 920 capable of transmitting the encoded signal. The encoder 910 receives video information and generates an encoded signal(s) therefrom. The encoder 910 may be, for example, the encoder 700 described in detail above.

The transmitter 920 may be, for example, adapted to transmit a program signal having one or more bitstreams representing encoded pictures and/or information related thereto. Typical transmitters perform functions such as, for example, one or more of providing error-correction coding, interleaving the data in the signal, randomizing the energy in the signal, and modulating the signal onto one or more carriers. The transmitter may include, or interface with, an antenna (not shown).

FIG. 10 shows a diagram of an implementation of a video receiving system 1000. The video receiving system 1000 may be configured to receive signals over a variety of media, such as, for example, satellite, cable, telephone-line, or terrestrial broadcast. The signals may be received over the Internet or some other network.

The video receiving system 1000 may be, for example, a cell-phone, a computer, a set-top box, a television, or other device that receives encoded video and provides, for example, decoded video for display to a user or for storage. Thus, the video receiving system 1000 may provide its output to, for example, a screen of a television, a computer monitor, a computer (for storage, processing, or display), or some other storage, processing, or display device.

The video receiving system 1000 is capable of receiving and processing video content. This is achieved by receiving an encoded signal(s) including video information.

The video receiving system 1000 includes a receiver 1010 capable of receiving an encoded signal, such as for example the signals described in the implementations of this application, and a decoder 1020 capable of decoding the received signal.

The receiver 1010 may be, for example, adapted to receive a program signal having a plurality of bitstreams representing encoded pictures. Typical receivers perform functions such as, for example, one or more of receiving a modulated and encoded data signal, demodulating the data signal from one or more carriers, de-randomizing the energy in the signal, de-interleaving the data in the signal, and error-correction decoding the signal. The receiver 1010 may include, or interface with, an antenna (not shown).

The decoder 1020 outputs video signals including video information. The decoder 1020 may be, for example, a decoder operable to decode signals conforming with the ITU-T H.264 standard.

Tests of performance of implementations have been conducted, and show that implementations result in elimination or near elimination of the annoying I-frame flickering artifact, and thus, greatly improve the overall perceptual video coding quality. It is also worthwhile mentioning that with I-frame de-flickering, lower PSNR will be yielded. This is because in our scheme a large amount of I-frame coding bits are spent to closely approach a lower quality no-flicker reference, rather than the original frame, which typically compromises the coding efficiency. In experiment, we generally observed a drop in PSNR of greater than 0.3 dB. This is, however, an example of the deficiency of PSNR as an objective video quality metric, because quality was improved.

The term “picture” as used herein includes, without limitation, a frame in a digital video, a field in a digital video, or a limited portion of a frame such as for example a macroblock or a partition of a macroblock. Additionally, the term “no flicker” and other similar expressions that are used throughout this application do not require the complete removal of flicker, but are, instead, intended to mean “reduced flicker”.

Various implementations described above operate on a macroblock level. Other implementations may operate at different levels. Examples include, for example, a frame or picture level, and a sub-macroblock level. A picture level implementation may, for example, generate an entire no-flicker reference picture, rather than simply a macroblock, and intercode (I-frame encode, for example) the entire no-flicker reference picture in a pass. This picture level implementation may also decide to generate no-flicker substitutes for the entire picture by, for example, pseudo-P-frame encoding the entire picture rather than selected macroblocks. A sub-macroblock level implementation may, for example, make decisions regarding whether or not to generate a no-flicker substitute (replacement) on a partition basis. For example, a 16×16 macroblock may be partitioned into 4×4 partitions, and a separate and independent decision may be made for each partition regarding whether or not to do a pseudo-P-frame encoding and to generate a no-flicker substitute for that partition.

The implementations described herein may be implemented in, for example, a method or a process, an apparatus, or a software program. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of equipment include video coders, video decoders, video codecs, web servers, set-top boxes, laptops, personal computers, cell phones, PDAs, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium having instructions for carrying out a process.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data either coded data generated by coding of a no-flicker reference (such as, for example, no-flicker reference 412), or a reconstruction (such as, for example, reconstruction 414) of a no-flicker reference. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

1. A method comprising:
performing a rate-distortion evaluation of multiple options for coding a source image, including at least one option for inter-coding the source image;
selecting an inter-coding option from the multiple options, based on the rate-distortion evaluation;
producing coded source data from an inter-coding of the source image;
decoding the coded source data to produce a modified source;
intra-coding the modified source to produce coded modified-source data; and
decoding the coded modified-source data to produce a reference image.

2. (canceled)

3. (canceled)

4. The method of claim 1, wherein the selected option is an optimal option based on the rate-distortion evaluation.

5. The method of claim 1 wherein the multiple options include at least one inter-coding mode from ITU-T H.264.

6. The method of claim 5 wherein the multiple options includes a SKIP mode from ITU-T H.264.

7. The method of claim 1 wherein the multiple options include at least one intra-coding mode from ITU-T H.264.

8. The method of claim 1 wherein the multiple options include (1) inter-coding with a 16×16 block size, (2) intra-coding with a 16×16 block size, and (3) intra-coding with a 4×4 block size.

9. The method of claim 1 wherein source image is at least part of a source picture in a series of pictures, and the reference image results in reduced flicker compared to the modified source when the series of pictures is coded, decoded, and displayed.

10. The method of claim 1 wherein the modified source is a reduced-flicker reference and the method further comprises determining whether or not to produce the reduced-flicker reference.

11. The method of claim 1 wherein:
the reference image is at least part of a reference picture in a group of pictures,
a previous picture is in a previous group of pictures, and
producing coded source data from an inter-coding of the source image comprises using at least a portion of the previous picture as a reference.

12. The method of claim 11 wherein the reference picture is an I-picture, and the previous picture is a P-picture.

13. The method of claim 11 wherein the portion is a macroblock.

14. The method of claim 1 wherein the source image is a macroblock of a source picture and the reference image is a macroblock of a reference picture.

15. The method of claim 1 further comprising inter-coding a subsequent image using the reference image as a reference.

16. The method of claim 15 further comprising providing a stream that includes the coded modified-source data and coded data from the inter-coding of the subsequent image.

17. The method of claim 15 wherein inter-coding the subsequent image comprises:
determining a residue between the subsequent image and the reference image; and
encoding the residue.

18. The method of claim 1 wherein producing coded source data from an inter-coding of the source image comprises using a quantization parameter higher than that used in intra-coding the modified source.

19. The method of claim 1 wherein:
the reference image is at least part of an I-picture in a group of pictures, and the subsequent image is at least part of a P-picture in the group of pictures, where the P-picture occurs after the I-picture.

20. The method of claim 1 wherein:
the source image is a macroblock in a source picture, and
the operations of (1) producing coded source data from an inter-coding of the source image, (2) decoding the coded source data, (3) intra-coding the modified source, and (4) decoding the coded modified-source data, are performed on a macroblock-by-macroblock basis for a plurality of macroblocks in the source picture, wherein performing the operations on a macroblock-by-macroblock basis allows the modified source for a given macroblock of the plurality to be discarded prior to performing the operations (1)-(4) on at least one other macroblock of the plurality.

21. The method of claim 1 wherein producing coded source data from an inter-coding of the source image comprises performing a partial inter-frame coding of the source image according to the ITU-T H.264 standard.

22. The method of claim 21 wherein performing the partial inter-frame coding comprises omitting entropy coding of the coded source data.

23. The method of claim 21 wherein performing the partial inter-frame coding comprises optimizing among fewer than all of the available modes of ITU-T H.264.

24. An apparatus comprising:
means for performing a rate-distortion evaluation of multiple options for coding a source image, including at least one option for inter-coding the source image;
means for selecting an inter-coding option from the multiple options, based on the rate-distortion evaluation;
means for producing coded source data from an inter-coding of the source image;
means for decoding the coded source data to produce a modified source;
means for intra-coding the modified source to produce coded modified-source data; and
means for decoding the coded modified-source data to produce a reference image.

25. The apparatus of claim 24, wherein the apparatus comprises an encoder that includes:
the means for producing coded source data from an inter-coding of the source image,
the means for decoding the coded source data,
the means for intra-coding the modified source, and
the means for decoding the coded modified-source data.

26. A processor-readable medium having stored thereon a plurality of instructions for performing:
performing a rate-distortion evaluation of multiple options for coding a source image, including at least one option for inter-coding the source image;
selecting an inter-coding option from the multiple options, based on the rate-distortion evaluation;
producing coded source data from an inter-coding of the source image;
decoding the coded source data to produce a modified source;
intra-coding the modified source to produce coded modified-source data; and
decoding the coded modified-source data to produce a reference image.

27. An apparatus, comprising:
a flicker evaluator configured (1) to perform a rate-distortion evaluation of multiple options for coding a source image, including at least one option for inter-coding the source image, and (2) to select an inter-coding option from the multiple options, based on the rate-distortion evaluation;
a no-flicker reference unit configured (1) to produce coded source data from an inter-coding of the source image, and (2) to decode the coded source data to produce a modified source; and
an intra-coding unit configured (1) to intra-code the modified source to produce coded modified-source data, and (2) to decode the coded modified-source data to produce a reference image.

28. (canceled)

29. The apparatus of claim 27 further comprising an inter-coding unit for inter-coding a subsequent image using the reference image as a reference.

30. An apparatus comprising a processor configured to perform the following:
performing a rate-distortion evaluation of multiple options for coding a source image, including at least one option for inter-coding the source image;
selecting an inter-coding option from the multiple options, based on the rate-distortion evaluation;
producing coded source data from an inter-coding of the source image;
decoding the coded source data to produce a modified source;
intra-coding the modified source to produce coded modified-source data; and
decoding the coded modified-source data to produce a reference image.

31. The apparatus of claim 30 further comprising a storage device for storing one or more images.

32. An apparatus comprising:
an encoder configured to perform the following:
performing a rate-distortion evaluation of multiple options for coding a source image, including at least one option for inter-coding the source image,
selecting an inter-coding option from the multiple options, based on the rate-distortion evaluation,
producing coded source data from an inter-coding of the source image,
decoding the coded source data to produce a modified source,
intra-coding the modified source to produce coded modified-source data, and
decoding the coded modified-source data to produce a reference image; and
a modulator configured to modulate and transmit the coded modified source data.

33. The method of claim 1 wherein the coded source data produced from the inter-coding of the source image is produced using the selected inter-coding option.
